(19) United States
(12) Patent Application Publication
(10) Pub. No.: US 2009/0106074 A1
(43) Pub. Date: Apr. 23, 2009

(54) BUSINESS TO MEDIA RESERVATION STANDARD

(75) Inventors: Jacek Waksmundzki, Warsaw (PL); Pawel Dernczuk, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,504

(22) Filed: Oct. 21, 2008

Related U.S. Application Data
(60) Provisional application No. 60/981,752, filed on Oct. 22, 2007.

(51) Int. Cl. G06Q 30/00; G06Q 10/00

(52) U.S. Cl. 705/8; 705/27

(57) ABSTRACT

A business to media (B2M) reservation standard provides for the visualization and reservation of various resources, simultaneously, in real time, and over multiple analog and digital media in multiple analog and digital marketplaces. The B2M reservation standard describes a business environment which may involve four roles (clients, marketplace suppliers, the scheduling agent supplier and offer providers) and three component types (media, marketplaces and a scheduling agent). In accordance with the B2M reservation standard, one embodiment of a method for facilitating reservations by clients of services offered by service providers includes: (a) conducting an offer construction process involving one or more services providers offering services available for reservation by customers and the scheduling agent supplier providing the scheduling agent to which offers of services are communicated; (b) conducting a marketplace construction process involving one or more marketplace suppliers providing one or more marketplaces and one or more media for customer communication with the marketplaces, wherein services available on the marketplaces are provided by the scheduling agent; and (c) conducting a reservation process wherein the single scheduling agent operating separately from the one or more marketplaces processes reservation requests from clients relating to services offered by the one or more service providers on the one or more marketplaces and presented to the clients through the one or more media.

### RELATED APPLICATION INFORMATION

This application claims priority from U.S. Provisional Patent Application Ser. No. 60/981,752 entitled “BUSINESS TO MEDIA RESERVATION STANDARD” filed on Oct. 22, 2007, which is incorporated by reference herein in its entirety.

### FIELD OF THE INVENTION

The present invention relates generally to standards for the reservation of resources, and more particularly to a standard by which resources in any business domain may be reserved using multiple analog and digital media.

### BACKGROUND OF THE INVENTION

A number of standards exist for conducting reservations between parties in communication network enabled environments. Generally, such existing standards for market segments deal with only one single marketplace, and usually only one media, and the interactions between the roles of the components and actors are not completely separated. Differentiated examples of each follow:
a. B2B (Business to Business)—a definition of relations between companies. This expression includes: preparation of offers, preparation of orders, order confirmation, payments, transaction completion, drawing up documents connected with transaction completion, and marketing. The implementation of this standard defines the agent as being undifferentiated from either the single marketplace (in this case, the offer provider fully delegates to the single marketplace/agent) or the offer provider (in this case, the offer provider retains confirmation control of the transaction). In most B2B solutions, there is also a single media (the Internet).
b. B2C (Business to Customer)—a definition of relations between one company and an end user, frequently connected by means of the Internet. The implementation of this standard defines the agent as being undifferentiated from the single marketplace and the offer provider (the offer provider provides the marketplace and acts as his own agent in any transactions).
c. C2B (Customer to Business)—e-business segment using the possibilities provided by Internet in order to reverse the traditional channel interactions between the multiple companies and the clients. The implementation of this standard defines the agent as being undifferentiated from the single marketplace (in one case) or undifferentiated from each offer provider (in the other case).
d. C2C (Consumer to Consumer)—the definition of Internet zones of business activity in the field of commerce and market oriented economy as seen by the private users. The Internet auctions may serve as an example of this type interaction. The implementation of this standard defines the agent as being undifferentiated from the single marketplace.
e. B2E (Business to Employee)—company “window displays” free information/services for access by all employees of the company. The implementation of this standard defines the agent as being undifferentiated from the single marketplace.

### SUMMARY OF THE INVENTION

The present invention provides a standard referred to herein as the business to media (B2M) reservation standard. The B2M reservation standard provides for the visualization of, and reservations of services, simultaneously, in real time, and over multiple analog and digital media in multiple analog and digital marketplaces. The B2M reservation standard is applicable to any type of service. A “service” may, for example, be considered an arrangement among a service provider and one or more customers by which the customer(s) receives/receive the use of one or more resources from the service provider. Use of the resource(s) may be received by the customer(s) for a scheduled period of time (e.g., for an hour, a day, a week, or the duration of a performance such as a movie, a play, or a sporting event), although it is also possible for the duration of the service to be open-ended. A “resource” may, for example, include a good that is exchanged between the service provider and the customer(s) as well as an activity that is performed for or on behalf of the customer(s). The activity may be performed by one or more individuals, one or more entities, one or more devices, or a combination of individuals, entities and/or devices. In general, a “customer” is any individual or entity that may receive a service from a service provider. The terms “customer” and “client” may be used interchangeably herein. Further, a “reservation” refers to any activity involving scheduling the delivery of a service. A “service provider” may be any individual or entity that possesses resources and is capable of providing the use of those resources to customers. Where the service provider owns a resource, ownership of the resource may be maintained by the service provider during the service.

The B2M reservation standard describes a business environment which involves four roles and three component types. The four roles are clients, marketplace suppliers, the scheduling agent supplier and service providers. The three component types are media, marketplaces and the scheduling agent.

Various aspects and advantages of the B2M reservation standard include separation of the multiple media from the marketplaces, separation of the marketplaces from the single scheduling agent, separation of the clients from the scheduling agent supplier, separation of marketplace suppliers from the scheduling agent supplier, separation of the service providers from the scheduling agent supplier, a delegation by the service providers to the single scheduling agent, the connection/representation of the service providers to multiple marketplaces and the client access to multiple marketplaces through multiple media. In this regard, the B2M reservation standard involves logical separation of each actor and each component from the other actors and components. Such separation provides universality of reservation systems and processes configured in accordance with the B2M reservation standard.

The B2M reservation standard describes the relationship between various roles within all commonly recognized market segments (B2B, B2C, C2B, C2C, B2E). The B2M reservation standard is a description of a business environment where the reservations involving many services and many clients and service providers (or more generally reservations and renting transactions) are served through one scheduling agent involving many marketplaces through multiple media.

The B2M reservation standard provides for multiple media access to many different marketplaces to be able to execute reservations for services of many service providers through a single scheduling agent. The service provider may, by registering with the scheduling agent with delegation to the scheduling agent, be represented on multiple marketplaces accessed by multiple media.

The commonly used market standards (B2B, B2C, C2B, C2C, B2E) refer to the specified environment and in a sense they are dealing with one single media, one single marketplace, and the interaction between the roles of the media, the marketplace, the scheduling agent, the client and the service provider is not completely separated. In contrast, the B2M reservation standard clearly separates these roles and delegates a reservation closure to the scheduling agent. This clear role separation and delegation makes possible multiple media and multiple marketplaces for clients and service providers while offering the same terms and conditions from each client and service provider. The advantage to the client and service provider is that no matter what media that the client chooses to use, the terms of reservations are guaranteed to be the same.

In accordance with one aspect, a method for facilitating reservations of services between customers and service providers is provided consistent with the B2M reservation standard. Such a method comprises the steps of: (1) conducting an offer construction process; (2) conducting a marketplace construction process; and (3) conducting a reservation process. The offer construction process involves one or more service providers and a scheduling agent supplier. In the offer construction process, the one or more service providers offer services available for reservation with customers, and the scheduling agent supplier provides a scheduling agent to which offers of services are communicated. The marketplace construction process involves one or more marketplace suppliers and the scheduling agent supplier. In the marketplace construction process, the one or more marketplace suppliers provide one or more marketplaces and one or more media for customer communication with the marketplaces, and services available on the marketplaces are provided by the scheduling agent. In the reservation process, a single scheduling agent operating separately from the one or more marketplaces processes reservation requests from customers relating to services offered by the one or more service providers on the one or more marketplaces and presented to the customers through the one or more media.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram showing a business environment with four groups of actors and three component types provided in accordance with the B2M reservation standard; and

FIG. 2 is a block diagram showing a business environment in accordance with the B2M reservation standard wherein the marketplaces and scheduling agent are implemented in an analog form.

### DETAILED DESCRIPTION

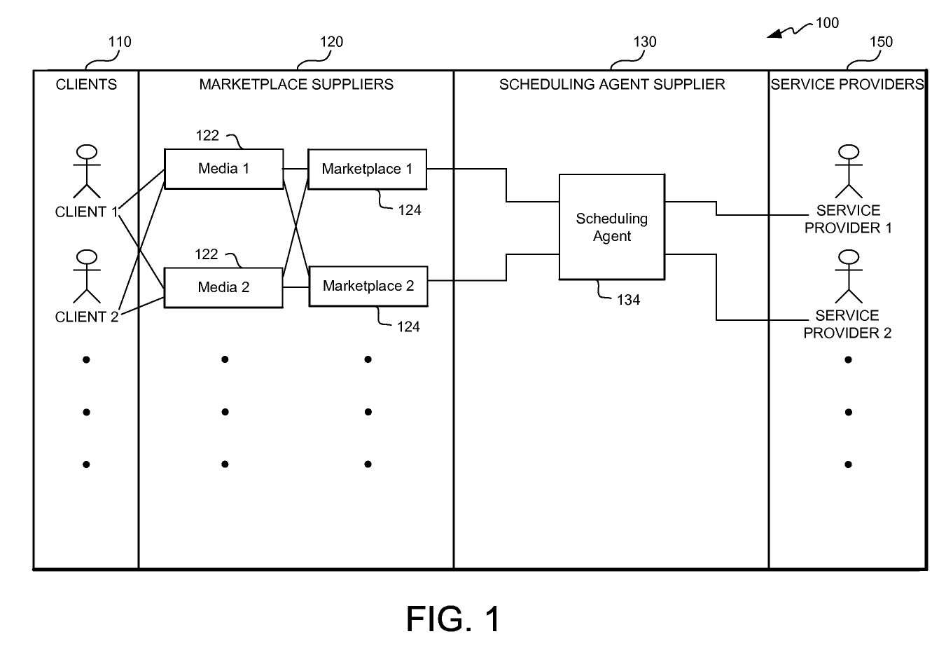

As shown in FIG. 1, the B2M reservation standard specifies a model 100 that includes four (4) groups of actors and three (3) component types. The four groups of actors interacting in this model are: clients 110, marketplace suppliers 120, the scheduling agent supplier 130 and service providers 150. Three component types used in the model are: media 122, marketplaces 124 and the scheduling agent 134. In accordance with the B2M reservation standard, the various actors and components undertake various roles and/or have various interactions. The marketplaces 124 may be implemented in any analog and/or digital forms where services are available through any media 122 to the clients 110, including, for example, in one embodiment as computer network enabled computer systems. The scheduling agent 134 may be implemented in any analog and/or digital form capable of processing all kinds of reservations (e.g. renting, reserving, scheduling, etc.) of all kinds of services, including, for example, in one embodiment as a computer network enabled computer system. The scheduling agent 134 has the capability to complete reservations from multiple marketplaces 124.

### Roles

The role of the clients 110 is to request reservations (e.g., reserve/schedule) of services available on multiple marketplaces 124 through multiple media 122. There may be one, two or more clients 110.

The role of marketplace suppliers 120 is to provide marketplaces 124 in any area of perceived market need (e.g. computer shops, car shops, hair-dressers, ski rentals, hotels, etc.) in forms suitable to the clients 110. There may be one or more marketplace suppliers 120. The marketplaces 124 may be implemented in analog (e.g. shops, stands at the fairs, agencies, etc.) and/or digital (e.g. WWW sites, DTV programs, mobile portals, etc.) forms. Marketplace suppliers 120 also provide media 122 for communication by clients 110 with marketplaces 124. Media 122 include analog (e.g. analog phone, printed materials, etc.) and/or digital (e.g. Internet, mobile phones, digital TV, etc.) types.

The role of marketplaces 124 is to offer services available from the scheduling agent 134 to the clients 110 and to mediate in reservations of those services between the scheduling agent 134 and the clients 110. One, two or more marketplaces 124 may be provided by the marketplace suppliers 120.

The role of the media 122 is to enable one-way (e.g. billboards, newspapers, etc.) and two-way (e.g. Internet, mobile phones, etc.) communication between clients 110 and marketplaces 124. One, two or more media 122 may be provided by the marketplace suppliers 120.

The role of the scheduling agent supplier 130 is to provide the scheduling agent 134 in any needed form, including analog (e.g. one man, organization, etc.) and/or digital (e.g. computer system). The scheduling agent 134 is responsible for exchanging information between service providers 150 and marketplaces 124 in both directions and is responsible for handling reservations on behalf of the service providers 150, if service providers 150 decide to delegate reservation handling to the scheduling agent 134.

The role of the scheduling agent 134 is to pass a service offer from the service providers 150 to the marketplaces 124 and inform service providers 150 about reservation requests from the marketplaces 124.

The role of service providers 150 is to have an offer of services, to give an access to those services to the scheduling agent 134 and to handle reservations incoming from scheduling agent 134 or (optionally) fully delegate reservations to the scheduling agent 134. There may be one, two or more service providers 150.

### Interactions

The B2M reservation standard provides a business environment where three main interactions (Service offer construction, Marketplace construction, and Reservation process), which are described below, take place:

Service Offer Construction

The service provider 150 defines services, which will be available for reservations and describes those services by naming their features such as: price, needed resources, place, etc. The service provider 150 creates delegations by deciding which services reservations the service provider 150 will handle and which will be handled by the scheduling agent 134. The service provider 150 adapts communication methods, provided by the scheduling agent supplier 130 for two-way communication between the service provider 150 and the scheduling agent 134. When communication channels are established, the service provider 150 places his offer and his delegations with the scheduling agent 134. The service provider 150 does not have to be connected permanently to the scheduling agent 134, but in the case that service provider 150 is not connected permanently to the scheduling agent 134, the services without delegations may not be available to the clients 110. Services without delegations may be available only when the service provider 150 is connected to the scheduling agent 134.

Marketplace Construction

The marketplace supplier 120 establishes communication methods with the scheduling agent 134 and receives information about business domains available to the scheduling agent 134. The marketplace supplier 120 chooses at least one business domain and makes services from this domain available to the clients 110 through at least one media 122. The marketplace 124 may stay permanently connected with the scheduling agent 134 and presents to the clients 110 up to date offers with available services only.

Reservation Process

The client 110 gets the information about the offers available on a marketplace 124 through a chosen media 122 that enables marketplace 124 to client 110 communication. If the chosen media 122 also supports a return communication channel, the client 110 uses it for making a reservation of a chosen service. When the chosen media 122 do not have a return channel, the client 110 uses other available media 122 with return communication capabilities to make this reservation. As the marketplace 124 stays connected to the scheduling agent 134, the reservation request is transmitted immediately from the marketplace 124 to the scheduling agent 134. If the scheduling agent 134 has been given delegation for the chosen services, it accepts or refuses the reservation. If the scheduling agent 134 has not been given delegation for the chosen services, the scheduling agent 134 informs the service provider 150 about the reservation request and the services provider 150 decides whether to accept it or refuse it. When the reservation status is set, the scheduling agent 134 informs the marketplace 124 about this status and the marketplace 124 makes this information available to the client 110.

In one embodiment, the B2M Reservation Standard takes form of a computer network based universal reservation system (CNBURS). An example of a CNBURS is more specifically described in a separate United States patent application filed contemporaneously herewith entitled “UNIVERSAL BUSINESS TO MEDIA RESERVATION SYSTEM” (which application claims priority from U.S. Provisional Application No. 60/981,760 filed Oct. 22, 2007), the entire disclosure of which is incorporated by reference herein. It is an example of a B2M reservation standard business environment where the marketplace 124 and the scheduling agent 134 are implemented in digital form.

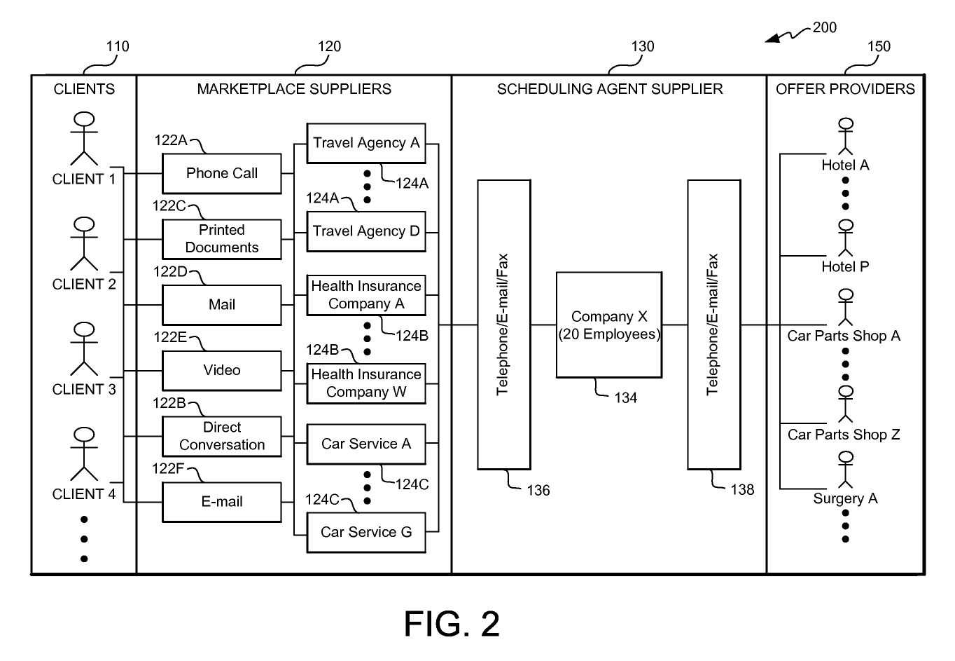

Another embodiment of the B2M reservation standard is shown in FIG. 2. It is an example of a B2M reservation standard business environment 200 where the marketplace(s) 124 and the scheduling agent 134 are implemented in analog form. Marketplaces 124 may, for example, take the form of one or more travel agencies 124A, one or more health insurance companies 124B and one or more car services 124C. The scheduling agent 134 is implemented as, for example, a company employing twenty people. The B2M reservation standard business environment 200 is not limited to the forms and number of the illustrated analog marketplaces 124A-124C within FIG. 2, and in other embodiments the analog marketplaces 124 may take other forms in addition to or in place of the illustrated travel agencies 124A, health insurance companies 124B and car services 124C. Likewise, the analog scheduling agent 134 is not limited to a company employing twenty people, and may, in general, be an individual or an organization of any type having any number of people.

In the present embodiment, there are six types of media 122 for communication between customers 110 and the marketplaces 124A-124C. The media 122 include two-way media 122 such as: telephone 122A and direct conversation 122B, and one-way media 122 such as: printed documents 122C, mail 122D, video 122E and e-mail 122F. The B2M transaction standard business environment 200 is not limited to the types and number of the illustrated media 122A-124F within FIG. 2, and in other embodiments the media 122 may take other forms in addition to or in place of the illustrated telephone 122A, direct conversation 122B, printed documents 122C, mail 122D, video 122E and e-mail 122F media 122.

The marketplaces 124A-124C and the scheduling agent 134 communicate by means of various media 136 such as, for example, telephone, fax and e-mail. The scheduling agent 134 and the service providers 150 also communicate by means of various media 138 such as, for example, telephone, fax and e-mail. The type media 136 by which the marketplaces 124A-124C and the scheduling agent 134 communicate may be the same or different from the type of media 138 by which the service providers 150 and the scheduling agent 134 communicate, and such media 136, 138 may be of various types in addition to or in place of one or more of the telephone, fax and email type media 136, 138.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A method for facilitating reservations of services between customers and service providers, said method comprising the steps of:
(a) conducting an offer construction process involving one or more service providers and a scheduling agent supplier, wherein the one or more service providers offer services available for reservation with customers and wherein the scheduling agent supplier provides a scheduling agent to which offers of services are communicated;
(b) conducting a marketplace construction process involving one or more marketplace suppliers and the scheduling agent supplier, wherein the one or more marketplace suppliers provide one or more marketplaces and one or more media for customer communication with the marketplaces and wherein services available on said marketplaces are provided by said scheduling agent; and
(c) conducting a reservation process wherein a single scheduling agent operating separately from the one or more marketplaces processes reservation requests from customers relating to services offered by the one or more service providers on the one or more marketplaces and presented to the customers through the one or more media.

2. The method of claim 1 wherein a service offered by the one or more service providers comprises an arrangement wherein a customer receives the use of a resource from a service provider.

3. The method of claim 2 wherein the customer receives use of the resource for a scheduled period of time.

4. The method of claim 2 wherein the service provider maintains ownership of the resource during the service.

5. The method of claim 2 wherein the resource comprises a good.

6. The method of claim 2 wherein the resource comprises an activity that is performed.

7. The method of claim 6 wherein at least a portion of the activity is performed by one or more individuals.

8. The method of claim 6 wherein at least a portion of the activity is performed by a device.

9. The method of claim 1 wherein said step of conducting an offer construction process comprises:
(i) defining one or more offers of services available for reservation with customers, wherein the one or more offers are defined by the one or more service providers and are included in one or more business domains;
(ii) creating delegations by the one or more service providers related to the one or more offers, wherein a delegation specifies whether the scheduling agent has authority on behalf of the a service provider to complete a reservation relating to an offer; and
(iii) placing the one or more offers and related delegations with the scheduling agent.

10. The method of claim 9 wherein said step of conducting a marketplace construction process comprises:
(i) establishing communication between the one or more marketplaces and the scheduling agent;
(ii) receiving information about business domains available to the scheduling agent;
(iii) selecting at least one business domain; and
(iv) providing information from the one or more marketplaces through the one or more media to customers about the offers available in the at least one business domain.

11. The method of claim 10 wherein said step of conducting a reservation process comprises:
(i) receiving at a marketplace a reservation request from a customer relating to an offer of services defined by a service provider;
(ii) transmitting the reservation request from the marketplace to the scheduling agent;
(iii) completing the reservation request at the scheduling agent when the scheduling agent is delegated authority by the service provider to complete reservations relating to the offer of services; and
(iv) informing the service provider of the reservation request when the scheduling agent is not delegated authority by the service provider to complete reservations relating to the offer of services.

12. The method of claim 9 wherein said step of conducting a reservation process comprises:
(i) receiving at a marketplace a reservation request from a customer relating to an offer of services defined by a service provider;
(ii) transmitting the reservation request from the marketplace to the scheduling agent;
(iii) completing the reservation request at the scheduling agent when the scheduling agent is delegated authority by the service provider to complete reservations relating to the offer of services; and
(iv) informing the service provider of the reservation request when the scheduling agent is not delegated authority by the service provider to complete reservations relating to the offer of services.

13. The method of claim 1 wherein said step of conducting a marketplace construction process comprises:
(i) establishing communication between the one or more marketplaces and the scheduling agent;
(ii) receiving information about business domains available to the scheduling agent;
(iii) selecting at least one business domain; and
(iv) providing information from the one or more marketplaces through the one or more media to customers about the offers available in the at least one business domain.

14. The method of claim 13 wherein said step of conducting a reservation process comprises:
(i) receiving at a marketplace a reservation request from a customer relating to an offer of services defined by a service provider;
(ii) transmitting the reservation request from the marketplace to the scheduling agent;
(iii) completing the reservation request at the scheduling agent when the scheduling agent is delegated authority by the service provider to complete reservations relating to the offer of services; and
(iv) informing the service provider of the reservation request when the scheduling agent is not delegated authority by the service provider to complete reservations relating to the offer of services.

15. The method of claim 1 wherein said step of conducting a reservation process comprises:
(i) receiving at a marketplace a reservation request from a customer relating to an offer of services defined by a service provider;
(ii) transmitting the reservation request from the marketplace to the scheduling agent;
(iii) completing the reservation request at the scheduling agent when the scheduling agent is delegated authority by the service provider to complete reservations relating to the offer of services; and
(iv) informing the service provider of the reservation request when the scheduling agent is not delegated authority by the service provider to complete reservations relating to the offer of services.

16. The method of claim 1 wherein an individual or entity acting as the scheduling agent supplier is separate from each individual or entity acting as a marketplace supplier.

17. The method of claim 1 wherein an individual or entity acting as the scheduling agent supplier is separate from each individual or entity acting as a service provider.

18. The method of claim 1 wherein an individual or entity acting as the scheduling agent supplier is separate from each individual or entity acting as a customer.

19. A method for facilitating reservations of services between customers and service providers, said method comprising the steps of:
(a) conducting an offer construction process involving one or more service providers and a scheduling agent supplier, wherein the one or more service providers offer services available for reservation with customers and wherein the scheduling agent supplier provides a scheduling agent to which offers of services are communicated, and wherein conducting an offer construction process comprises:
(i) defining one or more offers of services available for reservation with customers, wherein the one or more offers are defined by the one or more service providers and are included in one or more business domains;
(ii) creating delegations by the one or more service providers related to the one or more offers, wherein a delegation specifies whether the scheduling agent has authority on behalf of the a service provider to complete a reservation relating to an offer; and
(iii) placing the one or more offers and related delegations with the scheduling agent;
(b) conducting a marketplace construction process involving one or more marketplace suppliers and the scheduling agent supplier, wherein the one or more marketplace suppliers provide one or more marketplaces and one or more media for customer communication with the marketplaces and wherein services available on said marketplaces are provided by said scheduling agent, and wherein said conducting a marketplace construction process comprises:
(i) establishing communication between the one or more marketplaces and the scheduling agent;
(ii) receiving information about business domains available to the scheduling agent;
(iii) selecting at least one business domain; and
(iv) providing information from the one or more marketplaces through the one or more media to customers about the offers available in the at least one business domain; and
(c) conducting a reservation process wherein a single scheduling agent operating separately from the one or more marketplaces processes reservation requests from customers relating to services offered by the one or more service providers on the one or more marketplaces and presented to the customers through the one or more media, and wherein said conducting a reservation process comprises:
(i) receiving at a marketplace a reservation request from a customer relating to an offer of services defined by a service provider;
(ii) transmitting the reservation request from the marketplace to the scheduling agent;
(iii) completing the reservation request at the scheduling agent when the scheduling agent is delegated authority by the service provider to complete reservations relating to the offer of services; and
(iv) informing the service provider of the reservation request when the scheduling agent is not delegated authority by the service provider to complete reservations relating to the offer of services.

20. The method of claim 19 wherein a service offered by the one or more service providers comprises an arrangement wherein a customer receives the use of a resource from a service provider.

21. The method of claim 20 wherein the customer receives use of the resource for a scheduled period of time.

22. The method of claim 20 wherein the service provider maintains ownership of the resource during the service.

23. The method of claim 20 wherein the resource comprises a good.

24. The method of claim 20 wherein the resource comprises an activity that is performed.

25. The method of claim 24 wherein at least a portion of the activity is performed by one or more individuals.

26. The method of claim 24 wherein at least a portion of the activity is performed by a device.

27. The method of claim 19 wherein an individual or entity acting as the scheduling agent supplier is separate from each individual or entity acting as a marketplace supplier.

28. The method of claim 19 wherein an individual or entity acting as the scheduling agent supplier is separate from each individual or entity acting as a service provider.

29. The method of claim 19 wherein an individual or entity acting as the scheduling agent supplier is separate from each individual or entity acting as a customer.
